(19) United States
(12) Patent Application Publication
(10) Pub. No.: US 2014/0280560 A1
(43) Pub. Date: Sep. 18, 2014

(54) Capturing User Information In An Online System Based On Real-World Actions

(71) Applicant: Facebook, Inc., Menlo Park, CA (US)

(72) Inventor: Samuel Lessin, Palo Alto, CA (US)

(21) Appl. No.: 13/842,106

(22) Filed: Mar. 15, 2013

(51) Int. Cl. H04L 29/06

(52) U.S. Cl. CPC H04L 65/403
USPC 709/204

(57) ABSTRACT

A social networking system receives information identifying a location associated with a user and associates the location with the user. When the user provides location information to the social networking system, an entity associated with the location may request information items from the user. In one embodiment, the information items are requested through one or more questions presented to the user via the social networking system. The questions may also include a value proposition for the user, such as an offer or other incentive provided by the entity to the user in exchange for the user providing the information items to the entity. The information items may be stored by the social networking system and used to generate an object describing interactions between the user and the entity.

### BACKGROUND

The present invention relates generally to online systems and more particularly to surfacing interactions in an online system based on real-world actions.

In recent years, online systems, particularly social networking systems, have made it easier for users to share their interests and preferences in real-world concepts, such as their favorite movies, musicians, celebrities, soft drinks, hobbies, sports teams, and activities. These interests may be declared by users in user profiles and may also be inferred by social networking systems. Users can also interact with these real-world concepts through multiple communication channels on social networking systems, including interacting with pages on the social networking system, sharing interesting articles about causes and issues with other users on the social networking system, and commenting on actions generated by other users on objects external to the social networking system. Actions performed on objects by users on external websites, such as playing gaming applications, listening to music-streaming services, and reading document sharing systems, may also be captured by the social networking system. For example, social networking system users frequently share locations they have visited, such as restaurants, bars, parks, coffee shops, landmarks, and airports, with other social networking system users.

Often, social networking system users share locations with other social networking system users by posting content items with embedded geographic location coordinates. For example geographic location information may be associated with pictures, video data, check-in events, calendar events, third-party application data, or any other suitable data. These locations may correspond to businesses seeking to learn more about customers visiting their “brick & mortar” storefronts. However, privacy settings enforced by social networking systems prevents businesses from capturing and quantifying information based on information communicated to the social networking system.

For example, businesses are currently unable to use location information about social networking system users to create meaningful customer relationships on a social networking system. Because social networking system users may be connected to hundreds and thousands of objects on the social networking system, allowing businesses to capture additional directly from users enables businesses to better provide content to social networking system users to increase engagement with the businesses and with the social networking system. However, conventional social networking systems do not effectively allow businesses to receive real-time location information for users.

### SUMMARY

A social networking system receives information identifying a location associated with a user and associates the location with the user. When the user provides location information to the social networking system, an entity associated with the location may request information items from the user. In one embodiment, the information items are requested through one or more questions presented to the user via the social networking system. The questions may also include a value proposition for the user, such as an offer or other incentive provided by the entity to the user in exchange for the user providing the information items to the entity.

If a user provides the requested information items to the entity via the social networking system, the information items are stored by the social networking system and may be shared with other users or objects subject to the user's privacy settings. In one embodiment, an entity associated with the location may access these information items from an object (e.g., a page) created based on a connection between the user and the entity created by the user providing location information associate with the entity to the social networking system. A relationship profile between an object, such as a page, associated with the entity and the user may also be generated and provided by the social networking system to identify interactions between the user and the entity both in the real world and through the social networking system.

### BRIEF DESCRIPTION OF THE DRAWINGS

FIG. 1 is a block diagram illustrating a process of surfacing interactions in a social networking system based on real-world actions, according to one embodiment.

FIG. 2 is a block diagram of a system for surfacing interactions in a social networking system based on real-world actions, according to one embodiment.

FIG. 3 is a flow chart describing a process for capturing information based on real-world interactions of a social networking system user, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of a Social Networking System

A social networking system offers its users the ability to communicate and interact with other users of the social networking system. Users join the social networking system and add connections to a number of other users to whom they desire to be connected. Additionally, users of social networking system provide information describing themselves that is stored by the social networking system as user profiles. For example, users may provide their age, gender, geographical location, education history, employment history, or other suitable information to the social networking system. The information provided by users may be used by the social networking system to direct information to the user. For example, the social networking system may recommend social groups, events, and potential friends to a user. The social networking system may also enable users to explicitly express interest in one or more concepts, such as celebrities, hobbies, sports teams, books, and music. These interests may be used in a myriad of ways, including targeting advertisements and selecting relevant stories for a user about other users of the social networking system based on shared interests.

The social networking may store data about its users and other objects using a social graph that includes nodes connected by edges. Nodes include users and objects of the social networking system, such as web pages embodying concepts and entities. Edges connect nodes and represent a particular interaction between the objects or users corresponding to the two nodes. For example, an edge indicates when a user expresses an interest in a news article shared by another user about “America's Cup.” Hence, the social graph records interactions between users of the social networking system as well as interactions between users and objects of the social networking system by storing information in the nodes and edges that represent these interactions.

Additionally, the social graph may include custom graph object types and graph action types defined by third-party developers as well as social networking system administrators of the social networking system. This allows third-party developers or administrators to define attributes of graph objects and graph actions. For example, a graph object for a movie may have several defined object properties, such as a title, actors, directors, producers, year, and the like. A graph action type, such as “purchase,” may be used by a third-party developer on a website external to the social networking system to report actions performed by users of the social networking system on the external website. This allows the social graph to be “open,” by allowing third-party developers to create and use the custom graph objects and actions on external websites.

Third-party developers may enable social networking system users to express interest in web pages or other content provided by websites external to the social networking system. For example, web pages may be represented as page objects in the social networking system by embedding a widget, a social plug-in, programmable logic or, a code snippet (e.g., an iframe) into the web pages. Hence, any concept that can be embodied in a web page may become a node in the social graph on the social networking system. This allows social networking system users to interact with objects external to the social networking system relevant to a keyword or keyword phrase, such as “Justin Bieber.” Each interaction with an object may be recorded by the social networking system as an edge, which may allow advertisers to target advertisements based on user interactions with objects related to a keyword. This allows the advertisements to reach a more receptive audience including users previously performing an action related to the advertisement. For example, a merchandiser that sells Justin Bieber t-shirts, hats, and accessories may target ads for new merchandise to users that have recently performed one or more specific actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is described further in U.S. application Ser. No. 13/239,340 filed on Sep. 21, 2011, which is hereby incorporated by reference in its entirety.

The social networking system may additionally or alternatively maintain a collection of claims made by users and entities of the social networking system. A claim, as stored as a data structure in the social networking system platform, includes multiple components. For example, a claim includes one or more of: an author, an owner, an assertion, an audience, copyrights, and metadata associated with the claim by the social networking system. A user may make a number of “claims” on a social networking system, such as having attended a certain college, working for a certain company, being raised in a certain location, or being friends with other users of the social networking system. Claims on a social networking system include other declared user profile information, such as where the user currently lives and other biographical information about the user, including the age, gender, hometown, dating interests, relationship status, languages spoken, religious beliefs, and political views, as well as other information, including contact information, work and education experience, family members, historical events posted to a timeline, and favorite quotes.

Claims may be “authored” by “agents” of the social networking system. Examples of an agent include such as users, entities, and applications authorized to act on behalf of an agent. An author agent may designate an “owner” to assign ownership of a claim. An owner agent may specify certain settings for a claim, such as whether the claim may be copied by other agents and whether the claim may be boosted in rankings by other agents. Each claim includes an “assertion” having a “payload” of content that is stored by the social graph. The payload of content is the core of an assertion. A claim may have a claim type; for example, a claim that a user currently lives in San Francisco has a claim type of “current city.” The claim type may be specified by a metadata object provided by the social networking system. The structure of claims is further discussed in U.S. patent application Ser. No. 13/455,047, filed on Apr. 24, 2012, hereby incorporated by reference in its entirety.

A social networking system may allow its users to generate structured queries for content that return objects (e.g., users, entities, and/or agents) of the social networking system. For example, a searching user may generate a query for “people nearby that are hungry and like Lady Gaga.” Rather than searching for content items that include the keywords “people,” “hungry,” and “Lady Gaga,” the social networking system may interpret the query as the searching user searching for other users (people) that are hungry (users that have recent status messages indicating hunger or lack of recent meal) and that have performed actions on the social networking system indicating an interest in Lady Gaga (song listen actions, posts about Lady Gaga, explicit declaration of interest in Lady Gaga, connected to a page for Lady Gaga, etc.). Hence, the social networking system may use machine learning and regression analysis to select objects for inclusion in the search results based on the searching user's query.

Users may provide the social networking system with location information, allowing the social networking system to maintain data associating locations with users. For example, users may provide location information by checking-in to a location through the social networking system or may associate coordinates of a location with other content provided to the social networking system. After providing the social networking system with location information, a user may be prompted by the social networking system to provide additional information items to an entity associated with a location corresponding to the location information. For example, an entity associated with a business within a threshold distance of a user's location is notified by the social networking system of the user, so the entity may request additional information items from the user via the social networking system. If the user approves the request, the social networking system may provide one or more questions to the user for the entity. Additionally, the entity may provide the user with one or more incentives if the user provides information items by answering the questions. For example, the entity may provide the user with discounts on products or services provided by the entity, credit for a loyalty program provided by the entity, or other incentives for providing various information items. Information items provided to the entity via the social networking system may be stored by the social networking system and shared with other users or entities subject to the user's privacy settings

FIG. 1 illustrates a high-level block diagram of one embodiment of a process for surfacing interactions in a social networking system based on real-world actions. In the example of FIG. 1, a user 102 provides location information to the social networking system 100 (a “check-in event” 104). The location information provided to the social networking system 100 is associated with an entity, such as a business. Additionally, the entity may be associated with a page 108 or another object maintained by the social networking system 100. Because the check-in event 104 provides location information associated with an entity that is associated with a page 108, or another object, maintained by the social networking system 100, the received location information is communicated to a real world interface module 122.

In the example shown by FIG. 1, the real world interface module 122 comprises a user location awareness module 114, a user question module 116, a user permissions module 118, and a user interface module 120. In one embodiment, the user 102 provides geo-location coordinates 128 to the social networking system 100 used by the location awareness module 114 to identify the location of the user 102 and to identify entities associated with locations within a threshold distance of the user's location. For example, the geo-location coordinates 128 are communicated from the user's user device to the social networking system 100. However, the user 102 may provide location information using any suitable format in various embodiments.

If the user location awareness module 114 determines the user's location is within a threshold distance of a location associated with an entity, the real-world interface module 122 provides an interface to the user prompting the user 102 to provide the entity with additional information items. In one embodiment, the interface presents the user 102 with one or more value propositions from the entity, such as offers, rewards, discounts, and other incentives to add to the customer experience, in exchange for providing information items to the entity via the social networking system 100. For example, the real-world interface module 122 provides the user 102 with a request to provide information items to the entity.

If the user approves a request to provide additional information items, the user permissions module 118 stores the approval and the real world interface module 122 provides one or more questions to the user prompting the user for the additional information items. For example, the user question module 116 of the real world interface module 122 retrieves a user question object 110 from a user question store 106 associated with the page 108 or other object associated with the entity. The user question object 110 may include several questions 112, such as question A 112a, question B 112b, and question C 112c. The questions 112 may prompt the user for information about the user's interests or preferences or may prompt the user for information about interactions with the entity (e.g., a loyalty rewards number or other identifier used by the entity). As described above, if the user 102 responds to the questions with the requested information items, the entity provides one or more incentives to the user 102. Machine learning or regression analysis may be used to select the incentive provided to the user 102 by the entity.

The social networking system 100 may capture the user's responses to the questions 112 included in the user question object 110 and store them as graph objects 124 in a graph store 126 maintained by the social networking system 100. The stored graph objects 124 are associated with a user-specified privacy level, allowing the user 102 to limit access to the graph objects 124. Maintaining the graph objects 124 in the graph store 126 allows the social networking system 100 to maintain additional information about the user 102, which may be used to determine a relationship profile of the user's interactions with objects associated with the entity.

As the user 102 generates check-in events 104 identifying locations associated with various entities having pages 108 or other objects maintained by the social networking system 100, various interactions between the user 102 and the objects maintained by the social networking system 100 are stored. These interactions may then be aggregated into relationship profiles describing the user's interactions with objects associated with various entities. The relationship profiles may be represented by pages in the social networking system describing a user's interactions with an entity. For example, a profile page of “Starbucks & Michael Nguyen” describes interactions between a user, Michael Nguyen, and the entity STARBUCKS® to find out that Michael's favorite drink at STARBUCKS® is a Grande Soy Latte with Sugar-free Hazelnut, that he has visited STARBUCKS® in twenty different states and three countries, that he enjoys listening to Doris Day and Ella Fitzgerald while at a STARBUCKS®, and that he has had eighty-one visits in the past month. This information may be determined because the user 102 provided the entity STARBUCKS® with additional information items and allowed the stored graph objects 124 corresponding to the information items to be accessed by other users. In another embodiment, if the user 102 specifies the stored graph objects 124 corresponding to the information items are unable to be accessed by users other than the user 102 and an object corresponding to the entity, other users are unable to access the stored graph objects 124.

FIG. 1 and the other figures use like reference numerals to identify like elements. A letter after a reference numeral, such as “112a,” indicates that the text refers specifically to the element having that particular reference numeral. A reference numeral in the text without a following letter, such as “112,” refers to any or all of the elements in the figures bearing that reference numeral (e.g. “112” in the text refers to reference numerals “112a,” “112b,” and/or “112c” in the figures). For purposes of illustration, three questions 112a, 112b, 112c are shown in FIG. 1, although any number of questions may be included in various embodiments.

### System Architecture

FIG. 2 is a high level block diagram of one embodiment of a system environment suitable for claims-based querying in an online system, such as the social networking system 100. The system environment shown by FIG. 2 comprises one or more user devices 202, the social networking system 100, a network 204, and external websites 212. In alternative configurations, different and/or additional modules can be included in the system.

The user devices 202 comprise one or more computing devices for receiving user input as well as transmitting and/or data via the network 204. In one embodiment, the user device 202 is a conventional computer system executing, such as a desktop or laptop computer. Alternatively, the user device 202 may be a device having computer functionality, such as a personal digital assistant (PDA), mobile telephone, smart-phone, or another suitable device.

A user device 202 is configured to communicate via network 204. For example, the user device 202 executes an application, such as a browser application, allowing a user of the user device 202 to interact with the social networking system 100. Alternatively, the user device 202 interacts with the social networking system 100 through an application programming interface (API) running on a native operating system of the user device 202, such as IOS® or ANDROID™.

In one embodiment, the network 204 uses standard communications technologies and/or protocols. Thus, the network 204 may include communication channels using technologies such as Ethernet, 802.11, worldwide interoperability for microwave access (WiMAX), 3G, 4G, code division multiple access (CDMA), digital subscriber line (DSL), or any other suitable technology. Similarly, the networking protocols used on the network 204 may include multiprotocol label switching (MPLS), transmission control protocol/Internet protocol (TCP/IP), User Datagram Protocol (UDP), hypertext transport protocol (HTTP), simple mail transfer protocol (SMTP), and file transfer protocol (FTP). The data exchanged over the network 204 may be represented using technologies and/or formats including the hypertext markup language (HTML) and the extensible markup language (XML). In addition, all or some of the communication channels may be encrypted using conventional encryption technologies such as secure sockets layer (SSL), transport layer security (TLS), and Internet Protocol security (IPsec).

FIG. 2 includes a block diagram of one embodiment of the social networking system 100. In the embodiment shown by FIG. 2, the social networking system 100 includes a user question store 106, a graph store 126, a real world interface module 122, a node store 206, a web server 208, a content store 214, and an action logger 210. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 to one or more user devices 202 via the network 204; the web server 208 serves web pages, as well as other content, such as JAVA®, FLASH®, XML, and so forth. The web server 208 may receive and route messages between the social networking system 100 and the user devices 202. In various embodiments, the messages may be instant messages, queued messages (e.g., email), text and short message service (SMS) messages, or messages sent using any other suitable messaging technique. The user may send a request to the web server 208 to upload information, for example, images or videos that are stored in the claim store 206. Additionally, the web server 208 may provide application programming interface (API) functionality to send data directly to native user device operating systems, such as IOS®, ANDROID™, or RIM®. For example, a user may create a check-in event at a coffee shop in San Francisco, Calif. that is shared with other users connected to the user.

The action logger 210 receives communications from the web server 208 about user actions internal to or external to the social networking system 100. Based on the received communications the action logger 210 populates an action log with information about user actions. Examples of user actions include adding a connection to another user, sending a message to another user, uploading an image, reading a message from another user, viewing content associated with another user, attending an event created by another user, among others. In addition, a number of actions described in connection with other objects are directed at particular users, so these actions are also associated with those users.

An action log may be used by a social networking system 100 to log users' actions on the social networking system 100 as well as on external websites 212 that communicate information back to the social networking system 100. Information communicated to the social networking system 100 from an external website 212 is limited by users' privacy settings; additionally, user identifying information provided to external websites 212 for identifying users may be hashed or otherwise anonymized. Hence, the action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were accessed, purchasing activity, and other patterns from shopping and buying.

User account information and other related information for a user are stored as user profiles in the node store 206. The user profile information stored in node store 206 describes the users of the social networking system 100, including biographic, demographic, and other types of descriptive information, such as work experience, educational history, gender, hobbies or preferences, location, and the like. A user profile may also include other information provided by the user, for example, images or videos. In certain embodiments, images of users may be tagged with information identifying users of the social networking system 100 displayed in an image. The node store 206 also maintains references to the actions stored in an action log and performed by users on objects in the content store 214.

The node store 206 may also store edge information describing connections between users and other objects on the social networking system 100. Some edges may be defined by users, allowing users to specify their relationships with other users. For example, edges are generated when users express interest in a page on the social networking system 100, share a link with other users of the social networking system 100, or comment on posts made by other users of the social networking system 100.

Information describing edges and stored by the node store 206 includes such as affinity scores for objects, interests, and other users. Affinity scores may be computed by the social networking system 100 over time to approximate a user's interest for an object, interest, and other users in the social networking system 100 based on the actions performed by the user. Multiple interactions between a user and a specific object may be stored as a single edge in the node store 206, in one embodiment. For example, a user that plays multiple songs from Lady Gaga's album, “Born This Way,” may have multiple edges for the songs, but a single edge for Lady Gaga.

The content store 214 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 214, such as status updates, photos tagged by users to be associated with other objects in the social networking system, events, groups or applications. In some embodiments, objects are received from third-party applications or third-party applications separate from the social networking system 100. In one embodiment, objects in the content store 214 represent single pieces of content, or content “items.” Hence, users of the social networking system 100 are encouraged to communicate with each other by posting text and content items of various types of media through various communication channels. This increases the amount of interaction of users with each other and increases the frequency with which users interact within the social networking system 100.

As described above in conjunction with FIG. 1, the real-world interface module 122 receives location information associated with users and determines whether the received location information is within a threshold distance of a location associated with an entity having one or more objects maintained by the social networking system. If the user's location information is within a threshold distance of a location associated with an entity, the real-world user interface module 122 requests additional information items for the entity via the social networking system 100. The request may be presented via an interface provided by the social networking system 100, or presented via a social plugin or iframe on an interface provided by an external website 212, a desktop application, a native mobile application, or other suitable interface. If the user confirms the request for additional information items, the real-world interface module 122 prompts the user for information items; for example, the real-world interface module 122 presents one or more questions to the user, where responses to the questions provide the information items to the users. As described above in conjunction with FIG. 2, the received information items may be stored by the social networking system 100 in the node store 206.

### Storing Real World Interactions as Graph Objects in a Social Networking System

FIG. 3 illustrates a flow chart of one embodiment of a process for capturing user information in a social networking system based on real world actions. The social networking system 100 receives 302 location information associated with a user. For example, the social networking system 100 receives 302 an identification of a location or coordinates representing a location along with content provided by the user. As another example, the social networking system 100 receives 302 coordinates of a user device 202 associated with a user. Based on the received location information, the social networking system 100 determines 304 if the user is within a threshold distance of a location associated with an entity having an object maintained by the social networking system 100. The entity may be a business or other organization associated with one or more locations.

If the user is determined to be within a threshold distance of a location associated with an entity, the social networking system 100 requests 306 information items from the user. The information items are associated with the entity and provide information for use by the entity. If the social networking system 100 receives an authorization of the request from the user, the social networking system 100 prompts 308 the user for one or more information items. For example, the social networking system 100 retrieves one or more questions associated with the entity from a user question store 106 and prompts 308 the user with the retrieved one or more questions. The entity may specify questions for asking a user and may also specify an order in which the questions are presented to the user.

Responses from the user to the questions provide the social networking system 100 with the information items for the entity. For example, responses to the questions identify the user's favorite product provided by an entity, the user's favorite music, the user's favorite fashion designers, or other suitable information. The questions may be presented using a form in which the user fills out responses to the questions. As another example, a search box is provided along with each question, allowing the user to search for objects in the social networking system 100 providing an answer to the question.

One or more responses to the one or more user questions are stored 310 by the social networking system 100. For example, the one or more responses are stored as graph objects in the social networking system 100 that are searchable and may be presented to other social networking system users based on the user's privacy settings. In one embodiment, responses may be selected from a list of predetermined responses or other user responses in association with the place of business. In another embodiment, responses may identify objects stored by the social networking system 100 so a response to a question forms a connection between the user and the object corresponding to a response. In one embodiment, the stored responses may be analyzed with respect to the entity to provide a profile describing user interactions with the entity, as described above in conjunction with FIG. 1.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing, in a social networking system, information identifying one or more locations associated with entities
receiving location information indicating a location of a user of the social networking system;
determining if the location of the user is within a threshold distance of a location associated with an entity;
requesting one or more information items from the user if the location of the user is within the threshold distance of the location associated with the entity, the one or more information items providing content to the entity;
prompting the user for the one or more information items if the social networking system receives an approval of the request;
receiving content from the user for the one or more information items;
storing the content for the one or more information items and an association between the user; and
generating an object describing interaction between the user and the entity based at least in part on the content for the one or more information items.

2. The method of claim 1, wherein prompting the user for the one or more information items if the social networking system receives the approval of the request comprises:
retrieving one or more questions associated with the entity, a response to a question providing content for an information item; and
presenting the one or more questions associated with the entity to the user.

3. The method of claim 1, wherein requesting one or more information items from the user if the location of the user is within the threshold distance of the location associated with the entity comprises:
notifying the user of one or more incentives offered by the entity to the user if the user approves the request.

4. The method of claim 1, wherein storing the content for the one or more information items and an association between the user comprises:
applying one or more privacy settings associated with the user to the stored content, the one or more privacy settings limiting access of other social networking system users to the content.

5. The method of claim 1, wherein the object describing interaction between the user and the entity comprises a page associated with the user and the entity, the page including content describing one or more of the information items.

6. The method of claim 1, wherein the object describing interaction between the user and the entity is subject to one or more privacy settings of the user limiting access of other social networking system users to the object.

7. A method comprising:
storing, in a social networking system, information identifying one or more locations associated with entities
receiving location information indicating a location of a user of the social networking system;
determining if the location of the user is within a threshold distance of a location associated with an entity;
requesting one or more information items from the user if the location of the user is within the threshold distance of the location associated with the entity, the one or more information items providing content to the entity;
prompting the user for the one or more information items if the social networking system receives an approval of the request;
receiving content from the user for the one or more information items; and
storing the content for the one or more information items and an association between the user.

8. The method of claim 7, wherein prompting the user for the one or more information items if the social networking system receives the approval of the request comprises:
retrieving one or more questions associated with the entity, a response to a question providing content for an information item; and
presenting the one or more questions associated with the entity to the user.

9. The method of claim 7, wherein requesting one or more information items from the user if the location of the user is within the threshold distance of the location associated with the entity comprises:
notifying the user of one or more incentives offered by the entity to the user if the user approves the request.

10. The method of claim 7, wherein storing the content for the one or more information items and an association between the user comprises:
applying one or more privacy settings associated with the user to the stored content, the one or more privacy settings limiting access of other social networking system users to the content.

11. The method of claim 7, wherein storing the content for the one or more information items and an association between the user comprises:
storing a connection between the user and the entity in the social networking system.

12. A method comprising:
storing, in a social networking system, information identifying one or more locations associated with entities
receiving location information indicating a location of a user of the social networking system;
requesting one or more information items from the user if the location of the user is within a threshold distance of the location associated with an entity, the one or more information items providing content to the entity;
presenting the user with one or more questions associated with the entity if the social networking system receives an approval of the request, a response to a question providing an information item;
storing received responses to the one or more questions; and
generating an object describing interaction between the user and the entity based at least in part on the received responses to the one or more questions.

13. The method of claim 12, wherein requesting one or more information items from the user if the location of the user is within the threshold distance of the location associated with the entity comprises:
notifying the user of one or more incentives offered by the entity to the user if the user approves the request.

14. The method of claim 12, wherein storing received responses to the one or more questions comprises:
applying one or more privacy settings associated with the user to the received responses, the one or more privacy settings limiting access of other social networking system users to the received responses.

15. The method of claim 12, wherein the object describing interaction between the user and the entity comprises a page connected to the user and the entity, the page including content based on the received responses to the one or more questions.

16. The method of claim 12, wherein the object describing interaction between the user and the entity is subject to one or more privacy settings of the user limiting access of other social networking system users to the object.
